(19) United States
(12) Patent Application Publication
(10) Pub. No.: US 2007/0250429 A1
(43) Pub. Date: Oct. 25, 2007

(54) Prediction markets for assessing clinical probabilities of success

(75) Inventors: Bryan L. Walser, Berkeley, CA (US); Marc W. Elia, Mill Valley, CA (US)

Correspondence Address: MORRISON & FOERSTER LLP, 425 MARKET STREET, SAN FRANCISCO, CA, 94105-2482, US

(73) Assignee: Clinical Futures LLC, Mill Valley, CA (US)

(21) Appl. No.: 11/407,465

(22) Filed: Apr. 19, 2006

(51) Int. Cl. G06Q 40/00

(52) U.S. Cl. 705/37

(57) ABSTRACT

Prediction markets are used to determine the probability of an experimental therapeutic, diagnostic, or prophylactic candidate meeting clinical trial and post-trial goals, such as clinical trial endpoints and timelines. The prediction market processes buy and sell orders from market participants, while adjusting the prices of the securities according to the orders. The securities have specific meanings which correspond to goals in clinical trials or other outcomes in clinical candidate development. The price of a security determined by the market corresponds to the probability of the corresponding goal or outcome. The participants are selected for their expert knowledge of specific factors related to candidate development. Using appropriately selected securities and participants, the prediction market may be used to generate probabilities of success useful for long-range planning and valuation, determining production timelines and volumes, management of candidates in a development portfolio, and clinical management of patients by physicians.

### BACKGROUND

1. Field

The present application generally relates to prediction markets, and, more; particularly, to prediction markets for assessing clinical and other outcomes in those fields that require the successful conclusion of regulatory trials to gain marketing authorization, including pharmaceuticals, biotechnology, medical devices, vaccines, diagnostics, and the like.

2. Related Art

The clinical development process followed by the pharmaceutical, biotechnology, and other regulated healthcare industries is subject to various government requirements. For example, as specified in Title 21 of the Code of Federal Regulations (CFR) in the United States, drug developers are required to demonstrate that a new drug is safe and effective, and to identify the optimal dosage. Controlled clinical trials to establish safety and efficacy in humans, dosages, label contents, and possible adverse side effects are the only means for a drug developer to demonstrate to the U.S. Food & Drug Administration (FDA) that a new drug has shown “substantial evidence of effectiveness” as required by federal law.

Clinical trials are growing both in number and complexity. For example, the average new drug submission to the FDA now contains more than double the number of clinical trials, more than triple the number of patients, and a more than 50% increase in the number of procedures per trial since the early 1980s.

The clinical trial process is expensive and risky. Pharmaceutical companies spend a huge percentage of total annual pharmaceutical research and development funds on human clinical trials. Spending on clinical trials is growing at approximately 15% per year, almost 50% above the industry's sales growth rate. On average, a new drug does not reach the market for 12 years. Only one in five of the compounds tested in humans is approved by the FDA in the United States.

Similar pressures face all companies developing therapeutic, diagnostic, medical device or vaccine candidates, which require approval by a relevant regulatory body via submission of clinical trial information.

Such clinical trial failure rates contribute significantly to the challenges faced by the pharmaceutical, biotechnology, device and diagnostics industries. Improved guidance as to the individual likelihood of success for a particular clinical trial would greatly assist the portfolio management process, improve the efficiency of investments, and eventually save lives.

The current methods for predicting such probabilities are typically based on either or both of 1) a set of category-level retrospective benchmarks (e.g. inferring the likelihood of success for a specific molecule in a specific trial by observing the prior rates of success for similar modalities in similar therapeutic areas) and 2) a “Delphi-based” or “committee and consensus” process. Retrospective benchmarks rely on data sets which are too diffuse or abstract to be accurate; while committee- or Delphi-based processes often produce results which have nearly as great a magnitude of error, as a result of a set of well-described cognitive faults and biases intrinsic to group decision-making processes. Thus, in order for companies, investors, clinicians and patients in the pharmaceutical, biotechnology, and diagnostic industries to make effective decisions, new methods for the prediction of the likely outcomes for clinical and regulatory trials are required.

Such prediction methods will also be useful as tools for assisting decisions by any type of investor in companies with products that require the submission of clinical trial information for regulatory approval; as well as for the active clinical management of patients by physicians, including assistance in guiding the choice of clinical trial enrollment by patient

### SUMMARY

In one exemplary embodiment, a prediction market is used to determine a probability of a candidate meeting clinical trial goals. In this exemplary embodiment, a specific goal for the candidate is identified, where the goal is associated with a specific indication and a specific trial protocol. A security is structured to be traded by qualified market participants as a proxy for the candidate reaching the specific goal. A qualified group of participants is selected to trade the security, where the participants in the group have relevant knowledge. A prediction market is established for the selected group of participants to trade the security for the specific goal with sufficient liquidity to generate a robust market clearing price. Trading behaviors in the prediction market are observed, and the probability is determined from the observed trading behaviors.

### BRIEF DESCRIPTION OF THE DRAWINGS

FIG. 1 is an illustrative drawing of an environment for providing a prediction market according to one exemplary embodiment.

FIG. 2 shows an exemplary process for determining the probability of a candidate meeting clinical goals.

FIG. 3 shows another exemplary process for determining the probability of a candidate meeting clinical goals.

### DETAILED DESCRIPTION

The following description is presented to enable a person of ordinary skill in the art to make and use the invention. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the invention. Thus, the present invention is not intended to be limited to the examples described herein and shown, but is to be accorded the scope consistent with the claims.

It will be appreciated that the above description for clarity has described embodiments of the invention with reference to different functional units. However, it will be apparent that any suitable distribution of functionality between different functional units may be used without detracting from the invention. Hence, references to specific functional units are only to be seen as references to suitable means for providing the described functionality rather than indicative of a strict logical or physical structure or organization.

The exemplary embodiments described below can be implemented in any suitable form including hardware, software, firmware or any combination thereof. Different aspects of the exemplary embodiments may be implemented at least partly as computer software or firmware running on one or more data processors and/or digital signal processors. The elements and components of a particular exemplary embodiment may be physically, functionally and logically implemented in any suitable way. Indeed the functionality may be implemented in a single unit, in a plurality of units or as part of other functional units. As such, the exemplary embodiment may be implemented in a single unit or may be physically and functionally distributed between different units and processors.

Definitions

As used herein, the term “candidate” refers to any therapeutic, diagnostic, device or vaccine product in development.

The term “regulated healthcare industry” refers to industries where clinical trials are required to obtain marketing authorization, such as the pharmaceuticals, biotechnology, medical devices, vaccines, and diagnostics industries.

As used herein, the term “clinical trial goal” refers to any goal relating to an experimental therapeutic, diagnostic, medical device or vaccine candidate in clinical trials. Examples include the primary or secondary endpoints of the clinical trial, outcome of the clinical trial, trial timelines, and/or results of interaction with the FDA (e.g., is the candidate approved). An endpoint is, for example, a parameter that a clinical trial sets out to evaluate.

Another example of a clinical goal is whether a clinical trial will achieve statistically significant performance against the trial's endpoint(s), as determined arithmetically as described in the trial's clinical protocol. Additional examples of clinical trial goals include the vote share of the relevant advisory committee members (number of yes votes, number of no votes, number abstaining), and the advisory committee voting outcomes (balance positive, equivocal (tie) and balance negative). Yet another example of a clinical trial goal is the generation of FDA actions (generates letter of approval for marketing, generates approvable letter subject to various considerations, generates not approvable letter, generates other outcome).

Introduction

Accurate estimates of a clinical development project's probability of success can be generated using a prediction market, in which the probability of reaching a specified clinical trial goal is correlated to the values of securities in the market.

Prediction markets have existed since at least the early 1800s in such forms as guessing the weight of a pig at a county fair or guessing the number of objects contained in a jar. The average of many reasonably well-informed guesses about the parameters of a population tends to cluster near the actual values for those parameters. More complicated prediction markets, however, have arisen since the availability of distributed electronic communication networks such as the Internet. The first major demonstration of these markets was the Iowa Electronic Exchange, on which traders can place bets on the winner of the United States presidential election and other political contests. The results produced by these prediction markets have been far more accurate, and available far earlier, than results produced by traditional polling.

As will be described in more detail below with regard to various exemplary embodiments, prediction markets work best when they fulfill several key criteria. With respect to the participant population, participants in the market should have relevant information about the issue being assessed. The relevant information defines the relevant trading population, which is the set of participants. Participants should be active participants. Active participation may be encouraged through the use of incentives such as rewards for predictions that turn out to be correct. Each participant should independently assess an event's probability without reference to the assessments of other participants. Independent assessment can be achieved through mutual anonymity, and the degree of independence of the assessments is generally related to the degree of mutual anonymity among the participants. Failing to adequately address these three elements, relevant information, active participation, and independent assessment, will produce results that may be random, biased by starting positions, or biased by the opinions and hierarchy of others. In addition to these characteristics of the participant population, the analytical approach used is also important. The analytical approach should include a marketplace in which participants can purchase and trade event-linked futures contracts to achieve a pre-determined payout, where the market average contract price yields a weighted average arithmetic mean, which is a market-derived estimate of probability. Such market-driven probabilities have been shown to be more accurate than simple arithmetic means in many settings.

Prediction markets offer a solution to the problem of determining valuation or creating a strategic long-range plan (LRP) to guide investment and portfolio management in the regulated healthcare businesses including pharmaceuticals, biotechnology, medical devices, and diagnostics. In these businesses relying on regulated clinical trials to achieve marketing authorization, the probability of success of a project in meeting its next milestone in a trial, or in passing trials and being brought to the market, is the single most important determinant of a project's expected net present value (eNPV).

Attempts at predicting success of clinical development projects, e.g., candidate trials, with existing benchmark reference data and “modified Delphi” committee-and-consensus-based processes have typically produced inaccurate predictions—in many cases, wildly inaccurate. In particular, over the past ten years, currently-used prediction methods have been found to produce predictions that are nearly an order of magnitude in error. Interviews and process analysis indicate that three inter-related components were likely behind this process failure: project champions encouraging the continuance of projects likely to fail (in the absence of incentives to the contrary), a lack of project champions for projects likely to succeed (in deference to the perceived pre-dispositions and biases of senior management), and a general lack of specific engagement in assessing projects by those outside specific project teams. Prediction markets address these issues by combining personal incentives for true predictions (active participation) with a lack of bias towards false predictions (independence) among an informed population (relevant information). Prediction markets have associated parameters that affect the behavior, i.e., operation, of the markets. These parameters include, for example, the definitions and meanings of the securities traded in the market, the participants in the market, the method used to maintain market liquidity (i.e., trading volume), and the method used to provide incentive to the participants.

The exemplary embodiments described below include example methods for establishing prediction markets with parameters appropriate for using the markets to determine the probability of an experimental therapeutic, diagnostic, or prophylactic candidate meeting-clinical goals.

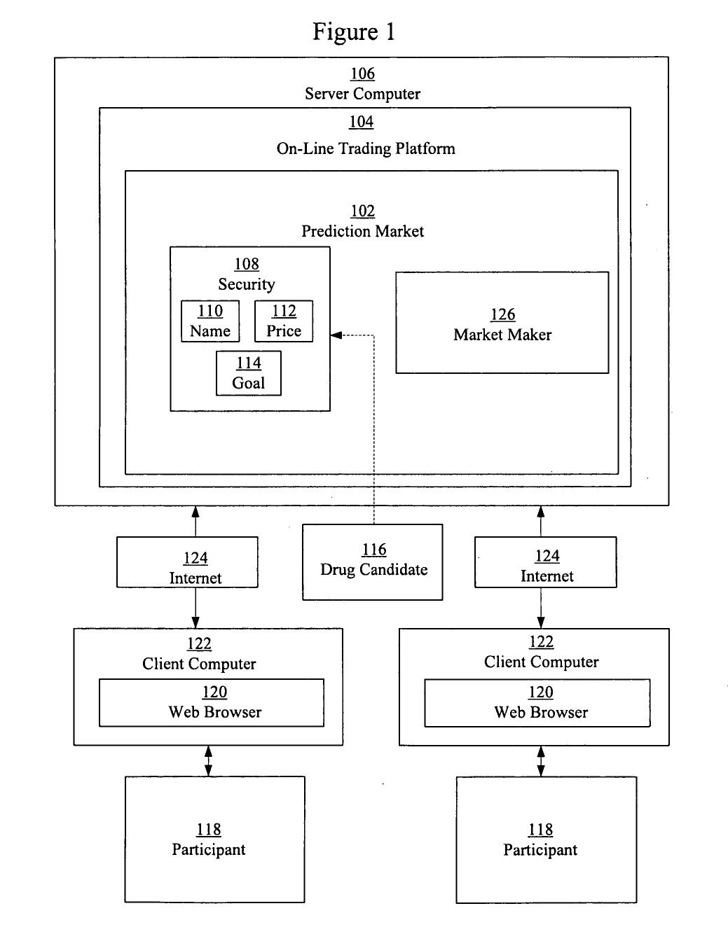

FIG. 1 is an illustrative drawing of an environment for providing a prediction market according to one exemplary embodiment. A prediction market 102 is provided by an on-line trading platform 104. As depicted in FIG. 1, the prediction market 102 can execute on a server computer 106.

The trading platform 104 establishes the prediction market 102 and accepts and processes buy and sell orders for a security 108. As depicted in FIG. 1, security 108 can include a name 110, a price 112, and a goal 114. As also depicted in FIG. 1, the security 108 is associated with a drug candidate 116.

The trading platform 104 adjusts the prices of the security 108 based upon bid prices in the buy orders and ask prices in the sell orders, and matching buyers with sellers, as is known to those skilled in the art. The buy and sell orders are submitted to the trading platform by participants 118. The participants 118 interact with the trading platform 104 through a software application such as a Web Browser 120, e.g. Microsoft™ Internet Explorer™ or the like. The Web Browser 120 can execute on a client computer 122, and interacts with the trading platform 104 via a network such as the Internet 124.

In the present exemplary embodiment, the prediction market 102 can include a market maker 126 configured to provide liquidity of the market and maintain sufficient price movement to maintain interest and trading levels while not distorting pricing signals. The market maker 126 can hold back a certain percentage of the security in the market.

The clinical trial outcomes prediction market of FIG. 1 extends the on-line trading platform by adding securities that represent goals in pharmaceutical development, groups of participants selected based upon their knowledge of specific aspects of pharmaceutical development, and a market maker that maintains liquidity in the relatively small participant groups encountered in pharmaceutical development.

Methods for selecting securities, selecting participants, and creating a market maker are described in more detail below.

Securities Selection

In some exemplary embodiments, the securities are Arrow-Debreu securities, which are futures contracts that pay a fixed amount if and only if a given outcome is achieved. The price of an Arrow-Debreu is the market's determination of the probability of the outcome being achieved. For example, if the security's price is $0.05, then the market has determined that there is a 5% probability of the outcome being achieved. Two securities, a success security and a failure security, are defined for each outcome. Participants who believe the outcome will be met will buy the success security and sell the failure security. Participants who believe the outcome will not be met will buy the failure security and sell the success security. The resulting buy and sell orders will adjust the prices of the buy and sell securities in the prediction market according to the rules of the on-line trading platform. The resulting market price of the success security is the probability that the outcome will be achieved according to the knowledge of the participants. Similarly, the resulting market price of the failure security is the probability that the outcome will not be achieved, according to the knowledge of the participants.

The candidate is associated with a security, as shown by the dashed line connecting the candidate to the security. The knowledge of the participant about the candidate is show by the dashed line connecting the candidate to the participant.

In one exemplary embodiment, the outcome is that a candidate for a particular indication (i.e., disease to be treated) meets a goal. Two securities are defined for each combination of candidate, indication, and goal. For example, the probability of a drug X for treatment of kidney cancer achieving its primary endpoint in its current clinical trial can be predicted by defining a success security and a failure security for drug X, as indicated for kidney cancer, reaching its primary endpoint in its current clinical trial.

Participant Selection

In one exemplary embodiment, the outcome is that a candidate for a particular indication (i.e., disease to be treated) meets a goal. Two securities are defined for each combination of candidate, indication, and goal. For example, the probability of a drug X for treatment of kidney cancer achieving its primary endpoint in its current clinical trial can be predicted by defining a success security and a failure security for drug X, as indicated for kidney cancer, reaching its primary endpoint in its current clinical trial.

The participants are selected based upon their knowledge of the clinical application and clinical development of the candidates for which a probability of success is being estimated. The particular type of knowledge desired in the participants will depend on the parameter for which the probability of success is being measured.

For example, if the prediction market is used to estimate the probability of success of the outcome of a clinical trial, participants are typically knowledgeable about biological features modulated by the candidate under examination, such as the biological target, pathway, cell type, or organ system affected by the candidate as well as the actions of the relevant administrative organization, such as the FDA. However, if the prediction market is used to estimate the probability of success of a candidate meeting certain production deadlines, the participants will preferably be those knowledgeable about development and manufacture of the type of candidate under examination.

According to one example, for any one market or security, participants are selected for their ability to provide insight into the fundamental uncertainty at issue. For example, a security that represents a pivotal Phase III trial in oncology tests the unique interaction between a chemical or biochemical entity, a targeted protein, pathway, cell, or organ, and the progression or modification of a clinical disease state. Therefore, participants in a prediction market for a Phase III oncology trial should be experts on at least one of the following topics: novel oncology drugs (industry or academic experts on oncology and oncology therapeutics), biostatistics and clinical development, and regulatory actions and decision making algorithms for evaluating novel therapeutics.

According to one example, a security representing a trial that compares an existing, approved manufacturing process to an improved, new manufacturing process should be traded by experts on at least one of the following topics: process development and manufacturing for the relevant therapeutic modality (small molecule vs. protein), and regulatory actions and decision making algorithms for evaluating novel production processes.

In one exemplary embodiment, the on-line trading platform includes features for providing incentives to trade in a corporate environment. Confidentiality and mutual anonymity are provided, and illegal gambling is avoided.

Market Maker Definition

In one exemplary embodiment, the on-line trading platform includes features for providing liquidity of the market and maintaining sufficient price movement to maintain interest and trading levels while not distorting pricing signals. In this case, a designated agent of the market sponsor participates in the marketplace with the intent of providing trading liquidity, that is, concluding outstanding trades from an allocation of shares and cash granted by the market sponsor in such fashion that trades are rapidly concluded, price continuity is preserved, and price movements are generally stabilized and adequately reflect an equilibrium of supply and demand. This agent can either be a human agent or a computer-based software system designed to achieve the same goal.

In one exemplary embodiment, the on-line trading platform and the equities that are traded provide information useful for both long-range planning and business development. More specifically, the prediction methods described herein may be used for achieving improved long-range planning, improved portfolio management in a development portfolio, and improved portfolio management in a portfolio of equities, in the field of therapeutic, diagnostic, or prophylactic product development. Furthermore, the prediction methods described herein provide improved identification of and abatement of risks previously considered unidentifiable and/or otherwise unmanageable.

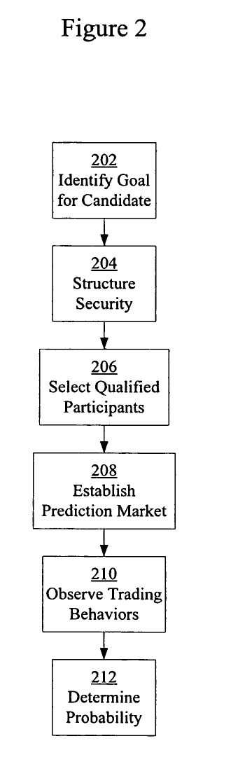

FIG. 2 shows an exemplary process for determining the probability of a drug meeting clinical trial endpoints.

In step 202, a specific goal is identified for a candidate. In the present exemplary process, the specific goal is associated with a specific indication and a specific trial protocol.

In step 204, an appropriate security is structured to be traded by qualified market participants as a proxy for the candidate reaching the specified goal. In the present exemplary process, the security is structure to reflect the probability that a trial will either meet or not meet its announced primary endpoint and/or secondary endpoint. If a single, discrete probability is to be determined (i.e., not a distribution of probabilities), an Arrow-Debreu security may be used, in which a “yes” security pays $1 if the endpoints are met, and a “no” security pays $1 if endpoints are not met. In this case, the price at which a security trades will be the same as the probability assigned by the market to either a “yes” or a “no” outcome, respectively. The security trades on the on-line trading platform available to incented and qualified participants.

In step 206, a qualified group of participants is selected to trade the security. In the present exemplary process, the participants selected will have some knowledge of drug development generally or of the specific conduct of the trial at issue, and will be incented by some combination of financial and or reputational remuneration. For example, the participants may include employees of a pharmaceutical development company in late-stage Research, Clinical Development, and Process & Product Development departments at or above a certain management level. The participants could also be key opinion leaders or members of another informed population. The participants may be acknowledged experts, i.e., published and referenced contributors to relevant literature, in at least one of the following subjects: pharmaceutical, diagnostic, medical device or vaccine development, a therapeutic area (e.g. cancer), a subset of a broad therapeutic area (e.g. pancreatic cancer, or solid tumors), a molecule or pathway modulated by a given candidate (e.g. the immune system; or toll-like receptors, or TLR-7), a drug manufacturing process, a regulatory filing process, evaluation of regulatory filings, and biostatistics and mathematics related to clinical development.

In step 208, a prediction market is established for the selected group of participants to trade the security for the specific goal. To provide remuneration to the participants, there may be, for example, 10,000 “yes” securities and 10,000 “no” securities, allowing a participant who corners the market up to a $20,000 return (although this pay-out is more likely to be split among many market participants). Gambling is avoided because individuals cannot lose value, only gain value. Participants were incented because they were issued “trading credits” which, although themselves worthless, permitted trading of securities, as well as an opening portfolio of an evenly balanced number (approximately 10,000/number of participants) of randomly-selected “yes” and “no” securities. Trading credits are then used to buy securities, and participants would buy and sell until the probabilities reflected in the price of their securities were indicative of the likelihood the market placed on either a “yes” or a “no” outcome. Liquidity is assured because a small number (approximately 10%) of the total securities are held back by a “market maker,” and used to clear bids from the bid queue.

In step 210, trading behaviors on the prediction market are observed. In step 212, the probability is determined from the observed trading behaviors. Thus, the probability is generated by the buying and selling of securities on the prediction market, and the probability typically corresponds to the value of a security on the prediction market that results from buying and selling of the security.

The probability generated by the prediction market may be compared to the “probability of success” generated by a committee-based Delphi process. The probability generated by the prediction market has been found to be more accurate than the Delphi estimates in instances predicting the probability of success for Phase III trials, the amount of marketable drug substance produced over a given time period, and the time and clearing price for a variety of investment transactions in the above-described fields. These improved estimates can be used for planning, portfolio management, and other instances where the clear identification and quantification of risks, which have otherwise been believed to be unidentifiable or unmanageable is important.

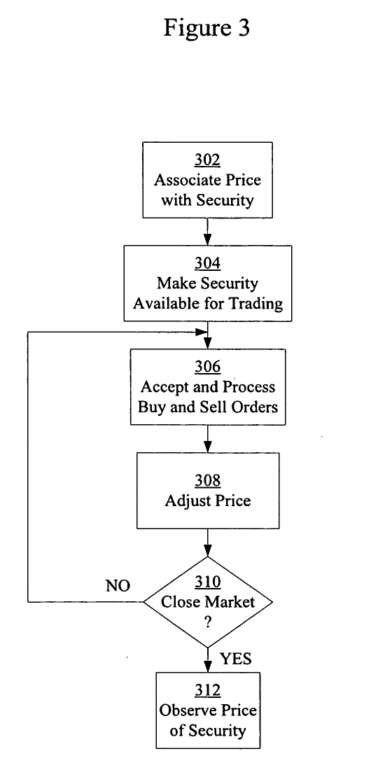

FIG. 3 shows another exemplary process for determining the probability of a drug meeting clinical trial endpoints.

In step 302, a price is associated with a security. The security is associated with a specific goal for a candidate. The security is traded as a proxy for the candidate reaching the specific goal.

In step 304, the security is made available for trading. In particular, the security is made available in an online market for buying and selling by participants.

In step 306, buy and sell orders for the security are accepted. In step 308, the price of the security is adjusted based on the buy and sell orders.

In step 310, a determination is made as to whether to close the market. In step 312, after the market has closed, the price of the security is observed.

In one exemplary application of a prediction market, the probability of a candidate meeting clinical trial timelines can be determined. In this exemplary application, the securities are structured as a series of Arrow-Debreu securities against various times, and traded in a series of markets (i.e., one market for “yes” and “no” in April, another market for “yes” and “no” in May, etc. Alternatively, securities can be traded for before or after a deadline, i.e., “yes” before May 15th versus “yes” after May 15th. The participants are selected as described above with respect to FIG. 2.

In another exemplary application of a prediction market, the probability of a candidate meeting clinical trial cost endpoints can be determined. In this exemplary application, the securities are be structured as either a “yes”/“no” at a particular target level—e.g., $100M for Phase III Trial X in Y indication, or as buckets e.g., “50-60M” “60-70M” “70-80M” “80-90” “90-100M” “>100M”.

In another exemplary application of a prediction market, the probability of a drug meeting production timelines and production volumes can be determined. In this exemplary application, the probabilities of production on a certain timeline can be determined using processes described herein to determine the probability of clinical trial goals, with modifications of the security structure and participant population in order to measure the appropriate probabilities.

In this exemplary application, the participants will include people with expertise in specifically relevant matters of manufacturing under current Good Manufacturing Practices (cGMP). The expertise can either be general or in the manufacturing of the specific candidate under investigation. The security can denominated either as “yes” or “no” by a certain deadline or the security can be a set of baskets of dates (by November, by December, etc.).

Similarly, the probabilities of production of a certain volume by a certain time can be determined using the processes disclosed herein for determining the probability of clinical trial goals, with modifications of the security structure and participant population in order to measure the appropriate probabilities. In this exemplary application, the participants will include people with expertise in relevant cGMP. The expertise can either be general or in the manufacturing of the specific product under investigation. The security can denominated either as “yes” or “no” of a certain volume by a certain deadline. An example is described in Example 2.

In this exemplary application, the participants will include employees with expertise in sales and marketing. The security can be a bucket of issues, each for a product to hit a certain sales mark at certain number of months after launch.

In another exemplary application of a prediction market, the probabilities of clinical trial and post-clinical trial goals determined using the prediction market can be used. In this exemplary application, the determined probabilities can be used as a tool for individuals who need to make decisions based upon information about these probabilities.

Another exemplary use of a prediction market includes a process of long range planning. In this exemplary use, long-range planning can be achieved using the probability of clinical trial goals, production timelines, production volumes, and overall revenues determined using the prediction market. The greater accuracy of the probability obtained using the prediction market allows more careful and dutiful allocation of capital on the part of the corporation or investor. Using the more accurate estimates of probability generated by the prediction market, one of skill can calculate more accurate valuations and make resource allocation decisions with greater certainty and accuracy. This will improve returns and sharply reduce wasteful investment in projects with a low assessed probability of success.

Another exemplary use of a prediction market includes a process of candidate portfolio management in a development portfolio. In this exemplary use, management of candidates in a development portfolio can be achieved using the probability of clinical trial goals determined using the prediction market. For example, whether the clinical trial will meet certain cost and market endpoints can be used to determine the priority for conducting a particular clinical trial.

Using the more accurate estimates of probability generated by the prediction market, one of skill can make improved capital allocations in the form of development budgets assigned to individual candidates with the net result of increasing the expected value of the total portfolio. Candidates with a high probability of success will receive increased funding, while candidates with a lower probability of success will receive little or no funding.

In this exemplary use, the decision to invest in a particular candidate should be communicated to the selected participants in the prediction market since the level of investment in a given project can, in some situations, change the probability of success in reaching certain clinical trial endpoints.

Exemplary embodiments can feature a process of management of a portfolio of equities via determination of the probability of events which can influence the value of the equities as well as the probability of the timing of such events. In these exemplary embodiments, the events can include clinical trial endpoints including binary events, such as the outcome of the clinical trials and threshold events, such as the outcome of interactions with regulatory authorities. The selected participants can include drug developers and regulatory experts. For example, methods to determine the probability of the outcome of a clinical trial can use a “yes”/“no” endpoint security. A method to determine the timing of an event can use a “bucket” security specifying a set of months (e.g., 8-10 months after submission, 10-12, 12-14, greater than 14).

Exemplary embodiments can provide processes for clinical management of patients by physicians via determination of the probability of clinical trial endpoints as well as post-clinical trial endpoints. Typical post-clinical trial endpoints that can be useful for clinical management include the timing the drug launches and market availability. The probability of success or failure of current clinical trials can be used to decide whether to enroll a patient in a particular trial. A physician may consult a prediction market to see whether a particular candidate is likely pass the Phase III trial and enroll his patient accordingly. For example, a physician checks a prediction market and sees that a Phase III trial of a drug for the indication being considered is trading “yes” at $0.65 (65%) and another Phase III trial is trading “yes” at $0.35 (35%). Therefore, the physician enrolls the patient in the first trial, rather than the second trial.

The probabilities of the timing of certain drug launches and market availability can also be used as a factor in designing a patient treatment plan. A physician can look at the prediction market estimate for market availability and treat the patient accordingly. For example a physician may avoid, severe chemotherapy for a pancreatic cancer patient if a drug is only two-months from availability or aggressive surgery if the drug is eight-ten months from availability.

### EXAMPLES

### Example 1

### Prediction Market to Predict a Clinical Trial Goal

In one exemplary application of an exemplary embodiment, a prediction market was used to correctly estimate the likelihood of success for a Phase III cancer drug in a trial for kidney cancer. In the market of Example 1, an Arrow-Dubreu security represented the likelihood of success of the cancer drug. The participants were selected from a group of experts on at least one of the following topics: novel oncology drugs (industry or academic experts on oncology and oncology therapeutics), biostatistics and clinical development, and regulatory actions and decision making algorithms for evaluating novel therapeutics. Liquidity of the market was ensured by a market-making trading algorithm that held back a 10% share of the market.

### Example 2

### Prediction Market to Predict a Chance of Failure for a Candidate

In another exemplary application of an exemplary embodiment, a prediction market was used to correctly estimate the chance of failure for an immune-based treatment for hepatitis C. The security, participant selection, and liquidity process used in Example 2 were the same as those used in Example 1.

### Example 3

### Use of a Prediction Market to Estimate Production Volumes

In another exemplary application of an exemplary embodiment, a prediction market was used to correctly estimate the quantities of doses of a vaccine. An existing committee-based Delphi process estimated 28 million, then 16-24 million, then “unknown” quantities of doses for Fluvirin, an influenza vaccine. The prediction market estimated that 14.4 million doses of vaccine would be delivered by Dec. 31, 2005. The actual number delivered was 14.5 million, thus demonstrating the superiority of the prediction market process over the traditional committee-based decision processes. In Example 3, the security corresponded to a likely dose amount. That is, the security was not an Arrow-Debreu security, but was instead a reserved number for each participant. Participants were people with knowledge of the situation, and issues involved and who were not involved in the committee-based decision process.

Although various exemplary embodiments have been described, it is hot intended to be limited to the specific form set forth herein. Rather, the scope of the present invention is limited only by the claims. Additionally, although a feature may appear to be described in connection with a particular exemplary embodiment, one skilled in the art would recognize that various features of the described exemplary embodiments may be combined. Moreover, aspects of various exemplary embodiments may stand alone as an invention.

Moreover, it will be appreciated that various modifications and alterations may be made by those skilled in the art without departing from the spirit and scope of the invention. The invention is not to be limited by the foregoing illustrative details, but is to be defined according to the claims.

What is claimed is:

1. A method of using a prediction market to determine a probability of a candidate meeting clinical trial goals, the method comprising:
identifying a specific goal for the candidate, wherein the goal is associated with a specific indication and a specific trial protocol;
structuring a security to be traded by qualified market participants as a proxy for the candidate reaching the specific goal;
selecting a qualified group of participants to trade the security, wherein the participants in the group have relevant knowledge;
establishing a prediction market for the selected group of participants to trade the security for the specific goal with sufficient liquidity to generate a robust market clearing price;
observing trading behaviors in the prediction market; and
determining the probability from the observed trading behaviors.

2. The method of claim 1, wherein the candidate comprises an experimental drug therapeutic, a diagnostic, a prophylactic, or a combination thereof.

3. The method of claim 1, wherein the candidate comprises a small molecule, a monoclonal antibody, or a protein therapeutic.

4. The method of claim 1, wherein selection of the participants is based upon relevance of knowledge of the participants to producing an accurate probability determination.

5. The method of claim 4, wherein the participants are knowledgeable in clinical application and clinical development of candidates for at least one therapeutic area under examination.

6. The method of claim 4, wherein the participants are knowledgeable about a biological feature modulated by the candidate under examination.

7. The method of claim 6, wherein the biological feature is a biological target, a pathway, a cell type, an organ system, or a combination thereof.

8. The method of claim 4, wherein the participants are knowledgeable about development and manufacture of the type of candidate under examination.

9. The method of claim 4, wherein the participants are knowledgeable about the actions of at least one relevant administrative organization.

10. The method of claim 9, wherein the organization comprises a regulatory body, an advisory committee, or a combination thereof.

11. The method of claim 10, wherein the organization comprises the United Status Food and Drug Administration.

12. The method of claim 1, wherein establishing the prediction market for the selected group of participants to trade the security for the specific goal with sufficient liquidity to generate a robust market clearing price comprises the step of:
adding a market maker to the market, wherein the market maker holds a percentage of the securities as held back securities, sells the held back securities to the participants, and buys securities to maintain the percentage of held securities.

13. The method of claim 1, wherein the goal is a clinical trial endpoint.

14. The method of claim 1, wherein the step of structuring a security comprises defining the security to reflect a candidate's probability of success.

15. The method of claim 1, wherein the step of structuring a security comprises defining the security to reflect a variable related to the candidate's probability of success.

16. The method of claim 15, wherein success comprises clinical success, commercial success, or a combination thereof.

17. The method of claim 1, wherein the step of structuring a security comprises choosing the security to reflect a likely distribution for a particular variable related to the candidate's probability of achieving at least one endpoint.

18. The method of claim 17, wherein the at least one endpoint is linked to clinical success, commercial success, or a combination thereof.

19. The method of claim 1, wherein observing trading behaviors comprises observing the equilibrium price of the security.

20. The method of claim 1, wherein observing trading behaviors comprises observing pricing trends for the security.

21. The method of claim 1, wherein observing trading behaviors comprises observing distribution of prices for the security.

22. The method of claim 1, wherein observing trading behaviors comprises observing volume, observing timing, and observing prices for individual bids, asks, and trades for the security.

23. A computer program product comprising program code for using a prediction market to determine a probability of a candidate meeting clinical trials goals, the computer program product comprising:
program code operable to associate a price with a security, wherein the security is further associated with a specific goal for the candidate, wherein the specific goal is associated with a specific indication and a specific trial protocol, and wherein the security is traded as a proxy for the candidate reaching the specific goal;
program code operable to make the security available in an online market for buying and selling by participants from a qualified group of participants, wherein the participants in the qualified group have relevant knowledge;
program code operable to accept and process buy and sell orders for the security from the participants; and
program code operable to adjust the price based upon the buy and sell orders to reflect the market's determination of the price.

24. The computer program product of claim 23, the computer program product further comprising:
program code operable to maintain a market maker, wherein the market maker buys and sells the securities to maintain an inventory, wherein the inventory comprises a percentage of the total number of securities in the market.

25. The computer program product of claim 24, wherein the percentage is ten percent.

26. The computer program product of claim 23, wherein the goal is a clinical trial endpoint.

27. The computer program product of claim 23, the computer program product further comprising:
program code operable to restrict access to the market to members of the group.

28. A method of using a prediction market to determine a probability of a candidate meeting clinical trial goals, comprising the steps of:
associating a price with a security, wherein the security is further associated with a specific goal for the candidate, wherein the specific goal is associated with a specific indication and a specific trial protocol, and wherein the security is traded as a proxy for the candidate reaching the specific goal;
making the security available in an online market for buying and selling by participants;
accepting and processing buy and sell orders for the security from the participants from a qualified group of participants, wherein the participants in the qualified group have relevant knowledge; and
adjusting the price based upon the buy and sell orders to reflect the market's determination of the price.

29. The method of claim 28, further comprising the steps of:
maintaining a market maker, wherein the market maker buys and sells the securities to maintain an inventory, wherein the inventory comprises a percentage of the total number of securities in the market.

30. The method of claim 29, wherein the percentage is ten percent.

31. The method of claim 28, wherein the goal is a clinical trial endpoint.

32. The method of claim 28, further comprising the step of:
restricting access to the market to members of the group.
